(19) United States
(12) Patent Application Publication
(10) Pub. No.: US 2024/0383081 A1
(43) Pub. Date: Nov. 21, 2024

(54) WELD NUT FEEDER PIN

(71) Applicant: GM GLOBAL TECHNOLOGY OPERATIONS LLC, Detroit, MI (US)

(72) Inventors: Jerome Longtine, Marine City, MI (US); Rolando Vera-Calzada, Commerce Twp, MI (US); Benjamin John LeBlanc, Ortonville, MI (US); John M. Mccoy, Copley, OH (US)

(73) Assignee: GM GLOBAL TECHNOLOGY OPERATIONS LLC, Detroit, MI (US)

(21) Appl. No.: 18/319,360

(22) Filed: May 17, 2023

(51) Int. Cl. B23P 19/00; B23K 11/00

(52) U.S. Cl. CPC B23P 19/006; B23K 11/0053

(57) ABSTRACT

A weld nut feeder pin includes a first pin end opposite a second pin end, and a pin body that extends from the first pin end toward the second pin end. The weld nut feeder pin includes a pin fluid conduit defined through the second pin end to extend to the first pin end and through the pin body, and the pin fluid conduit is configured to receive a pressurized fluid. The weld nut feeder pin includes a plurality of outlet conduits defined through the pin body so as to be in communication with the pin fluid conduit. Each of the plurality of outlet conduits is spaced apart about a perimeter of the pin body and extends along an axis. The axis is oblique to a longitudinal axis of the weld nut feeder pin.

### INTRODUCTION

The technical field generally relates to nut feeder systems, and more particularly relates to a weld nut feeder pin for use with a nut feeder system.

In certain industries, such as automotive manufacturing, it can be desirable to weld a fastener, such as a nut, to a component to facilitate assembly. For example, a weld nut may be welded to a component such as a sheet metal panel, and the weld nut may subsequently receive a fastener to couple the sheet metal panel to another component. In one example, the weld nut may be welded to the component via resistance welding. In this example, the weld nut may be transported, by a nut feeder, to an electrode, which is used to resistance weld the weld nut onto the component. In certain instances, the nut feeder may be unable to retain the weld nut as it moves toward the electrode, which causes the weld nut to drop prior to reaching the electrode.

Accordingly, it is desirable to provide a weld nut feeder pin for a nut feeder system, which retains a weld nut during movement to an electrode. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a weld nut feeder pin. The weld nut feeder pin includes a first pin end opposite a second pin end, and a pin body that extends from the first pin end toward the second pin end. The weld nut feeder pin includes a pin fluid conduit defined through the second pin end to extend to the first pin end and through the pin body, and the pin fluid conduit is configured to receive a pressurized fluid. The weld nut feeder pin includes a plurality of outlet conduits defined through the pin body so as to be in communication with the pin fluid conduit. Each of the plurality of outlet conduits is spaced apart about a perimeter of the pin body and extends along an axis. The axis is oblique to a longitudinal axis of the weld nut feeder pin.

The pin fluid conduit terminates within the first pin end at a planar endwall, and a radius is defined between the planar endwall and an inlet of each of the plurality of outlet conduits. The planar endwall extends along a second axis, and the second axis is substantially perpendicular to the longitudinal axis. Each of the plurality of outlet conduits extend along the axis to be defined at an angle relative to the longitudinal axis, and the angle is an acute angle. The angle is less than fifty degrees. The plurality of outlet conduits are substantially evenly spaced apart about the perimeter of the pin body and have a uniform diameter along the axis. The first pin end tapers to a first terminal end, and the second pin end includes a second terminal end, with a plurality of threads defined on the weld nut feeder pin from the second terminal end toward the pin body. The plurality of threads are spaced apart from the pin body by an unthreaded region. The weld nut feeder pin includes a pin flange defined at an end of the pin body so as to be spaced apart from the first pin end and the second pin end, and the pin flange is configured to be a seat for a weld nut associated with a nut feeder system. The pin flange includes a pair of opposed tool flats that are configured to receive a tool. The pin body defines a sidewall that surrounds a central bore, the central bore defines a portion of the pin fluid conduit through the pin body, and a radius is defined between an inlet of each of the plurality of outlet conduits and the sidewall proximate the central bore. The pin fluid conduit is defined as a counterbore. The weld nut feeder pin is additively manufactured from a polymer-based material.

Further provided is a weld nut feeder pin. The weld nut feeder pin includes a first pin end opposite a second pin end, and a pin body that extends from the first pin end toward the second pin end. The pin body defines a sidewall and a central bore. The weld nut feeder pin includes a pin fluid conduit defined to extend through the second pin end and through the central bore of the pin body to terminate at an endwall defined within the first pin end. The pin fluid conduit is configured to receive a pressurized fluid. The weld nut feeder pin includes a plurality of outlet conduits defined through the pin body so as to be in communication with the pin fluid conduit. Each of the plurality of outlet conduits is spaced apart substantially evenly about a perimeter of the pin body, and each of the plurality of outlet conduits extends at an angle relative to a longitudinal axis of the weld nut feeder pin. The angle is an acute angle. Each of the plurality of outlet conduits includes an inlet, with a first radius defined between the inlet of each of the plurality of outlet conduits and the endwall, and a second radius is defined between the inlet of each of the plurality of outlet conduits and the sidewall.

Each of the plurality of outlet conduits extend along a first axis that is oblique to the longitudinal axis, each of the plurality of outlet conduits has a uniform diameter along the first axis, the endwall extends along a second axis, and the second axis is substantially perpendicular to the longitudinal axis. The weld nut feeder pin includes a pin flange defined at an end of the pin body so as to be spaced apart from the first pin end and the second pin end, and the pin flange is configured to be a seat for a weld nut associated with a nut feeder system. The pin flange includes a pair of opposed tool flats that are configured to receive a tool. The first pin end tapers to a first terminal end, and the second pin end includes a second terminal end, with a plurality of threads defined on the weld nut feeder pin from the second terminal end toward the pin body. The plurality of threads are spaced apart from the pin body by an unthreaded region. The weld nut feeder pin is additively manufactured from a polymer-based material.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of a manufacturing system that includes a weld system and a nut feeder system including a weld nut feeder pin in accordance with various embodiments;

FIG. 2 is a perspective view of the weld nut feeder pin of FIG. 1, in which a weld nut is coupled to the weld nut feeder pin;

FIG. 3 is a perspective view of the weld nut feeder pin of FIG. 1;

FIG. 4 is a cross-sectional view of the weld nut feeder pin and weld nut, taken along line 4-4 of FIG. 2;

FIG. 4A is a cross-sectional detail view of the weld nut feeder pin taken at 4A on FIG. 4;

FIG. 5 is an end view of the weld nut feeder pin of FIG. 1, which illustrates a plurality of outlet conduits associated with the weld nut feeder pin;

FIG. 6 is an end view of the weld nut feeder pin of FIG. 1, which illustrates a pair of tool flats associated with the weld nut feeder pin;

FIG. 7 is a rear perspective view of another exemplary weld nut feeder pin for use with the nut feeder system of FIG. 1;

FIG. 7A is a cross-sectional view of a portion of the weld nut feeder pin, taken along line 7A-7A of FIG. 7; and

FIG. 8 is an end view of the weld nut feeder pin of FIG. 7, which illustrates a plurality of outlet conduits associated with the weld nut feeder pin.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. In addition, those skilled in the art will appreciate that embodiments of the present disclosure may be practiced in conjunction with any number of systems, and that the systems described herein are merely exemplary embodiments of the present disclosure. It should be noted that many alternative or additional functional relationships or physical connections may be present in an embodiment of the present disclosure. As used herein, the term “substantially” denotes within 10% to account for manufacturing tolerances and the term “about” denotes within 10% to account for manufacturing tolerances.

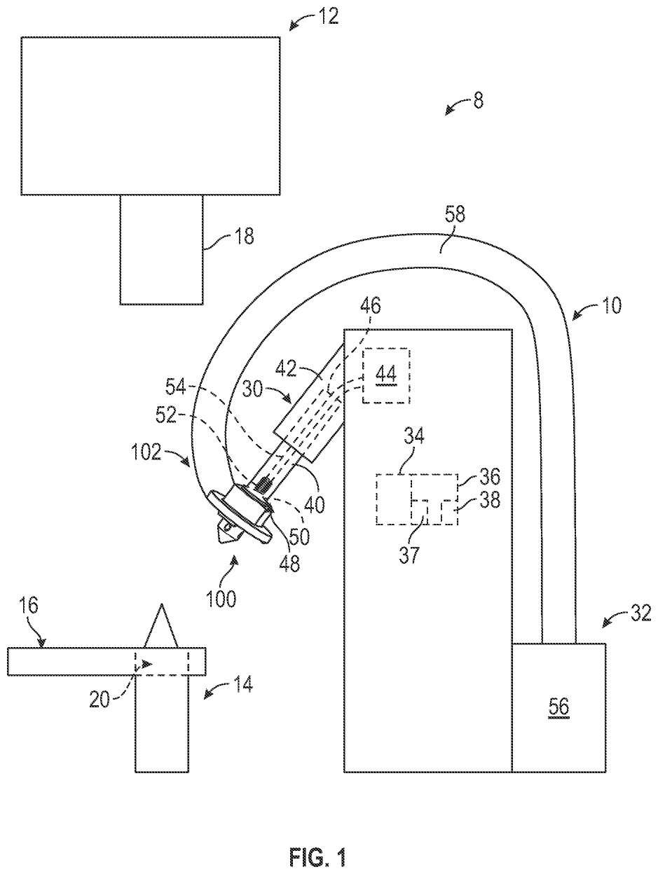

With reference to FIG. 1, an exemplary weld nut feeder pin 100 is shown for use with a nut feeder system 10 associated with a weld system 12 of a manufacturing system 8. In one example, the nut feeder system 10 is used to supply a weld nut 102 to a second, lower electrode 14 for welding to a component 16 by the weld system 12 during a manufacturing process. In one example, the weld system 12 is a resistance welding system, and includes the lower electrode 14 spaced a distance apart from a first, upper electrode 18. The lower electrode 14 and the upper electrode 18 cooperate to resistance spot weld the weld nut 102 to the component 16. In this example, the component 16 is a panel, which is composed of metal or metal alloy, and is stamped, extruded, cast, forged, additively manufactured, etc. The component 16 includes a bore 20, and the weld nut 102 is configured to be coupled to the component 16 so as to surround the bore 20 to receive a mechanical fastener, such as a bolt.

In one example, the weld system 12 includes or is in communication with a source of electric current to supply the electric current to the electrodes 14, 18. The electrodes 14, 18 may be held by a fixture, which enables the electrodes 14, 18 to apply pressure to the weld nut 102 and/or the component 16. In one example, the lower electrode 14 is substantially conical at least at an end of the lower electrode 14 proximate the component 16, and is configured to be positioned within at least a portion of the weld nut 102 and the component 16 to orientate the weld nut 102 on the component 16. The upper electrode 18 is substantially cylindrical, and at least partially hollow to fit over at least a portion of the weld nut 102. The electrodes 14, 18 may be composed of a conductive material, including, but not limited to, copper. The electric current flows through the electrodes 14, 18, the weld nut 102 and the component 16 to form a weld pool between a portion of the weld nut 102 and the component 16 that solidifies to couple the weld nut 102 to the component 16. It should be noted that in certain embodiments, the weld system 12 and the nut feeder system 10 may comprise a single system that feeds and welds the weld nut 102 to the component 16.

The nut feeder system 10 transports or delivers the weld nut 102 to the lower electrode 14 for welding. The nut feeder system 10 may comprise any suitable nut feeder system 10, including, but not limited to a Seki Air Rod Feeder, commercially available from Seki Feeder, Inc. of Erlanger, Kentucky. Briefly, the nut feeder system 10 includes an actuator system 30 and a nut supply source 32. The nut feeder system 10 may include a human-machine interface 34 and a controller 36 to control the actuator system 30. For example, the controller 36 includes a processor 37 and a memory 38 that stores instructions for the operation of the actuator system 30 and optionally, the nut supply source 32 to transport the weld nut 102 to the lower electrode 14 based on the receipt of an input, such as input from the human-machine interface 34 and/or an input from the weld system 12. For example, the human-machine interface 34 may include a button, switch, lever, touchscreen overlaid on a display, etc., which may be manipulated by a user to initiate the actuator system 30 and/or nut supply source 32 to provide the weld system 12 with the weld nut 102.

In one example, the actuator system 30 is a pneumatic actuator, which includes a cylinder 40, a rod 42 and a source of pressurized fluid or pressurized fluid source 44, such as pressurized air. The pressurized fluid source 44 may be a pressurized fluid tank, etc. The rod 42 is movable relative to the cylinder 40 between at least a retracted position, in which the weld nut 102 may be loaded onto the rod 42, and an extended position, in which the weld nut 102 is delivered by the rod 42 onto the lower electrode 14. In one example, the cylinder 40 is in fluid communication with and coupled to the pressurized fluid source 44 to receive the pressurized fluid to actuate or move the rod 42 between the retracted position and the extended position. In this example, the rod 42 includes a first rod end 46 coupled to and disposed within the cylinder 40, and an opposite second rod end 48 that is coupled to the weld nut feeder pin 100. In one example, the second rod end 48 includes a counterbore 50, which defines a plurality of rod threads 52. As will be discussed, the weld nut feeder pin 100 is threadably coupled to the plurality of rod threads 52 such that the weld nut feeder pin 100 may be removed and replaced as needed throughout the operation of the nut feeder system 10. In addition, the rod 42 includes a rod fluid passage 54, which extends from the first rod end 46 to the second rod end 48. The rod fluid passage 54 enables the pressurized fluid from the pressurized fluid source 44 to flow through the weld nut feeder pin 100 when the weld nut feeder pin 100 is coupled to the rod 42. As will be discussed, the weld nut feeder pin 100 cooperates with the rod fluid passage 54 of the nut feeder system 10 to retain the weld nut 102 on the weld nut feeder pin 100 during transport of the weld nut 102 to the lower electrode 14.

The nut supply source 32 supplies the weld nut 102 to the second rod end 48. The nut supply source 32 may include a hopper 56 or other receptacle that receives the weld nuts 102 in bulk, and a conduit or guide 58 that transports the weld nuts 102 from the nut supply source 32 to the nut feeder system 10. The guide 58 may be supplied with a pressurized fluid, such as air, from the pressurized fluid source 44, for example, to supply a force to move the weld nuts 102 through the guide 58. It should be noted that other techniques may be employed to deliver the weld nuts 102 to proximate the second rod end 48. In one example, a flange or bracket may be coupled to the nut feeder system 10 proximate the second rod end 48 and coupled to the guide 58 to enable one of the weld nuts 102 to be positioned and aligned for the weld nut feeder pin 100 to receive the weld nut 102 as the rod 42 moves from the retracted position to the extended position.

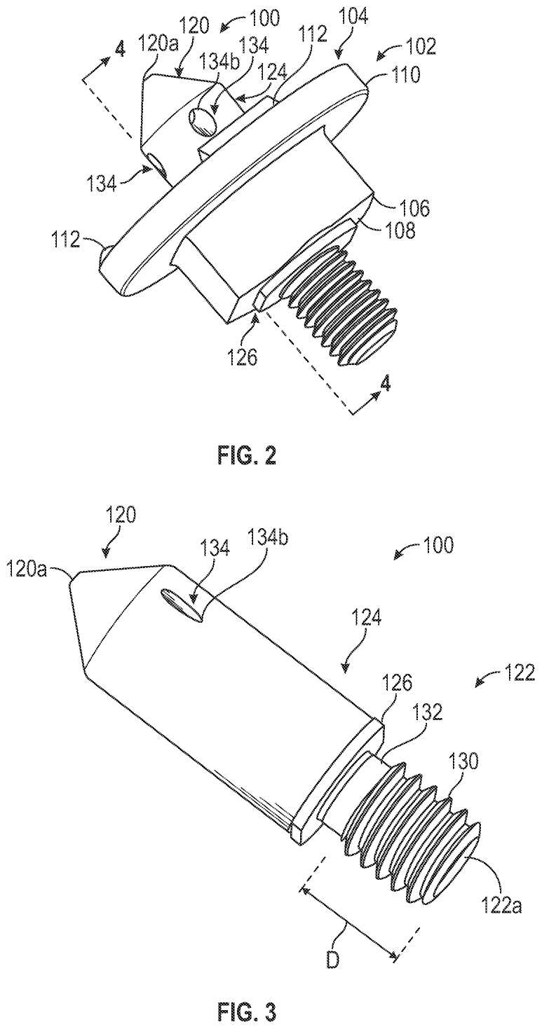

With reference to FIG. 2, the weld nut 102 is shown coupled to the weld nut feeder pin 100. The weld nut feeder pin 100 is shown in FIG. 2 uncoupled from the rod 42 of the nut feeder system 10. In this example, the weld nut 102 is composed of metal or metal alloy, and may be cast, forged, additively manufactured, etc. The weld nut 102 may have any predetermined size for use with the component 16, including, but not limited to, metric 10 millimeter (mm) (M10), metric 8 millimeter (mm) (M8), etc. The weld nut 102 is substantially cylindrical. A diameter of the weld nut feeder pin 100 is sized to correspond with the size of the weld nut 102 to be used with the component 16 such that a respective size of the weld nut feeder pin 100 may be associated with a particular size of the weld nut 102. In one example, the weld nut 102 has a first weld nut end 104 opposite a second weld nut end 106. An inner bore 108 extends through the weld nut 102 from the first weld nut end 104 to the second weld nut end 106. The inner bore 108 may be internally threaded, and in other embodiments, the weld nut 102 may be devoid of internal threads. The inner bore 108 is sized to be received on the weld nut feeder pin 100, and the weld nut feeder pin 100 extends through the weld nut 102 for transporting the weld nut 102 to the lower electrode 14 (FIG. 1). The first weld nut end 104 includes a weld flange 110 and a plurality of weld tabs 112. The weld flange 110 extends circumferentially about the weld nut 102 and is configured to contact the component 16 when the weld nut 102 is received on the lower electrode 14. The weld tabs 112 extend axially outward from the weld flange 110 and are configured to melt to form the weld pool to couple the weld nut 102 to the component 16. The second weld nut end 106 is annular, and is configured to contact a portion of the weld nut feeder pin 100 as the weld nut feeder pin 100 transports the weld nut 102 to the lower electrode 14 (FIG. 1).

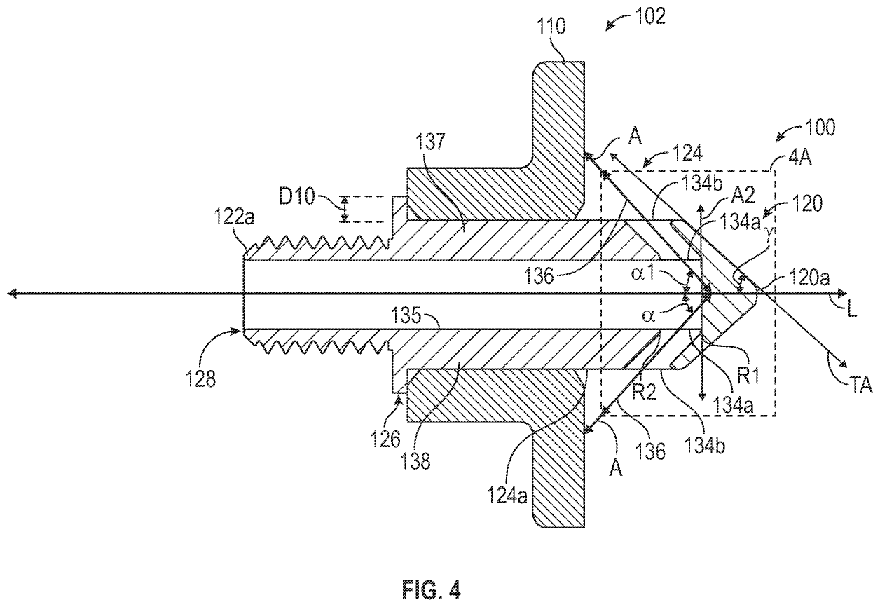

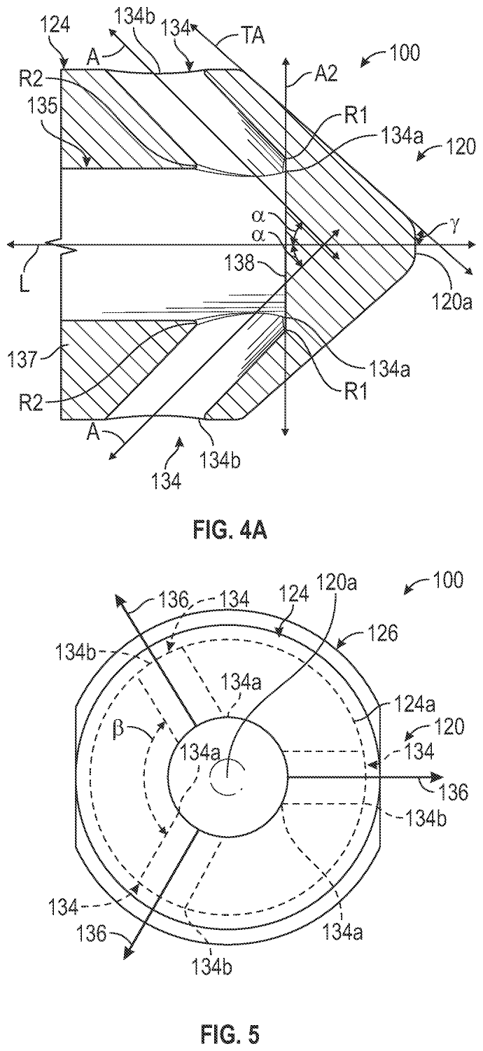

With reference to FIG. 3, the weld nut feeder pin 100 is shown in greater detail. In this example, the weld nut feeder pin 100 is composed of a polymer based material, including, but not limited to glass fiber-filled nylon 12. The use of glass fibers for reinforcement of the nylon improves an abrasion resistance of the weld nut feeder pin 100. It should be noted, however, that different polymer based materials and/or different reinforcement materials may be employed to manufacture the weld nut feeder pin 100 based on the particular nut feed system or manufacturing system. The weld nut feeder pin 100 is additively manufactured, via selective laser sintering (SLS), for example. By additively manufacturing the weld nut feeder pin 100, the weld nut feeder pin 100 may be easily replaced and easily manufactured to account for various sizes of weld nuts 102. The weld nut feeder pin 100 includes a first pin end 120, a second pin end 122, a pin body 124, a pin flange 126 and a pin fluid conduit 128 (FIG. 4). As will be discussed, the pin fluid conduit 128 extends from the second pin end 122 through the pin body 124 and terminates within the first pin end 120.

The first pin end 120 is opposite the second pin end 122. The first pin end 120 is substantially frustoconical, and tapers from the pin body 124 to a first terminal end 120a. The taper along the first pin end 120 assists in positioning the weld nut feeder pin 100 through the inner bore 108 of the weld nut 102 (FIG. 2) as the rod 42 of the nut feeder system 10 (FIG. 1) is advanced. Stated another way, with reference to FIGS. 4 and 4A, the first pin end 120 extends from the first terminal end 120a along a taper axis TA to the pin body 124, and the taper axis TA is oblique to a longitudinal axis L of the weld nut feeder pin 100. In one example, the taper axis TA forms an angle γ with the longitudinal axis L. The angle γ is an acute angle, and in one example, is between about 40 degrees to about 50 degrees, and for example, is about 48.5 degrees. By forming the first pin end 120 to extend along the taper axis TA, at the angle γ, the first pin end 120 guides the weld nut 102 onto the weld nut feeder pin 100, which ensures that the weld nut 102 is seated on the weld nut feeder pin 100 as the rod 42 moves to the extended position. A chamfer is defined between the first pin end 120 and the pin body 124 to further assist in seating the weld nut 102 on the weld nut feeder pin 100.

With reference back to FIG. 3, the second pin end 122 includes a plurality of pin threads 130. The pin threads 130 are defined from a second terminal end 122a of the second pin end 122 toward the pin flange 126 over a threaded distance D. The pin threads 130 are defined about an exterior surface of the weld nut feeder pin 100 and are configured to mate or engage with the rod threads 52 of the rod 42 (FIG. 1) to couple the weld nut feeder pin 100 to the rod 42. In this example, the pin threads 130 are defined to extend about the circumference of the weld nut feeder pin 100 from the second terminal end 122a over the threaded distance D so as to be spaced apart from the pin flange 126. This results in an unthreaded region 132 defined between the pin threads 130 and the pin flange 126. The unthreaded region 132 ensures proper spacing between the rod 42 and the weld nut 102 when the weld nut feeder pin 100 is coupled to the rod 42. The unthreaded region 132 also increases a strength of the weld nut feeder pin 100 between the pin threads 130 and the pin flange 126. In this example, the pin threads 130 comprise metric 6 millimeter (mm) threads (M6), however, other thread spacings may be used.

The pin body 124 is cylindrical, and interconnects the first pin end 120 and the pin flange 126. In this example, the pin body 124 defines at least one or a plurality of outlet conduits 134, and an internal central bore 135 that defines a portion of the pin fluid conduit 128. The outlet conduits 134 are in fluid communication with the pin fluid conduit 128 via the internal central bore 135, and as will be discussed, distribute the pressurized fluid outward from the pin body 124 to retain the weld nut 102 on the pin body 124 during transportation of the weld nut 102 to the lower electrode 14 (FIG. 1). With reference to FIG. 4, a cross-section is shown with the weld nut 102 coupled to the weld nut feeder pin 100. In this example, the pin body 124 has three outlet conduits 134 (FIG. 5). The outlet conduits 134 are each in communication with the pin fluid conduit 128 via the internal central bore 135, which is defined through a center of the weld nut feeder pin 100. Generally, the pin fluid conduit 128 extends along the longitudinal axis L of the weld nut feeder pin 100, which also comprises a centerline for internal central bore 135 and the pin fluid conduit 128. In this example, each of the outlet conduits 134 extends along an axis A, which is substantially oblique to the longitudinal axis L. The axis A is substantially a centerline of each of the outlet conduits 134. Stated another way, with additional reference to FIG. 4A, each of the outlet conduits 134 is defined along the axis A so as to be at an angle α relative to the longitudinal axis L. In one example, the angle α is an included angle, and is an acute angle. In one example, the angle α is between about 40 degrees to about 50 degrees, and in this example, the angle α is about 46 degrees. The angle α of each of the outlet conduits 134 is different and less than the angle γ of the taper of the first pin end 120. Generally, the angle α and the angle γ remain about the same regardless of the size (or diameter) of the weld nut feeder pin 100. By defining the outlet conduits 134 along the axis A, at the angle α, each of the outlet conduits 134 directs the pressurized airflow substantially along the direction of the arrows 136 at an angle onto the weld flange 110. This retains the weld nut 102 on the weld nut feeder pin 100 as the rod 42 moves to position the weld nut 102 on the lower electrode 14 (FIG. 1).

Each of the outlet conduits 134 is cylindrical and has an inlet or a first outlet end 134a opposite an outlet or second outlet end 134b. As each of the outlet conduits 134 is cylindrical, the first outlet end 134a and the second outlet end 134b are each circular. The outlet conduits 134 are defined through a sidewall 137 of the pin body 124. The sidewall 137 surrounds the internal central bore 135, and in one example, the sidewall 137 has a reduced thickness to enable the internal central bore 135 to supply a larger volume of the pressurized fluid to the outlet conduits 134. The first outlet end 134a is defined at least partially within the first pin end 120, and the second outlet end 134b is defined at an exterior surface 124a of the pin body 124. In one example, each of the outlet conduits 134 is defined uniformly, with a constant diameter along a length of each of the outlet conduits 134 from the first outlet end 134a to the second outlet end 134b. In one example, each of the outlet conduits 134 has a diameter of about 1.5 millimeters (mm) to about 2.25 millimeters (mm). Generally, the diameter of each of the outlet conduits 134 is sized to be as large as possible to direct a maximum amount of the pressurized fluid onto the weld nut 102. It should be noted that in other examples, the first outlet end 134a may have a diameter that is different that a diameter of the second outlet end 134b. Each of the outlet conduits 134 connects to the internal central bore 135 that defines the portion of the pin fluid conduit 128 within the pin body 124 to direct the pressurized fluid through the sidewall 137 of the pin body 124 to the exterior surface 124a to contact the weld nut 102.

Generally, as shown in FIG. 4, the pin fluid conduit 128 is defined through the weld nut feeder pin 100 so as to be substantially cylindrical. In one example, the pin fluid conduit 128 is defined as a cylindrical counterbore, which extends from the second terminal end 122a to proximate the first terminal end 120a. In this example, the pin fluid conduit 128 terminates or ends within the first pin end 120 along a planar endwall 138. Stated another way, with additional reference to FIG. 4A, the endwall 138 extends along an axis A2, which is substantially perpendicular to the longitudinal axis L, and substantially oblique to the axis A of each of the outlet conduits 134. By terminating at the endwall 138, the pressurized fluid is directed into each of the outlet conduits 134. In one example, the pin fluid conduit 128 has a diameter of about 4.0 millimeters (mm) to about 5.0 millimeters (mm). The pin fluid conduit 128 is in fluid communication with the rod fluid passage 54 to receive the pressurized fluid from the pressurized fluid source 44. Stated another way, the pin fluid conduit 128 is fluidly coupled to the pressurized fluid source 44.

It should be noted that the first outlet end 134a of each of the outlet conduits 134 is integrally formed with the endwall 138 along a first radius R1, which assists in directing the pressurized fluid into the respective outlet conduit 134 by reducing losses as the flow transitions from the endwall 138 into the respective outlet conduit 134. In one example, the first radius R1 is about 0.05 millimeters (mm) to about 0.25 millimeters (mm). In addition, the first outlet end 134a of each of the outlet conduits 134 is integrally formed with the sidewall 137 of the pin body 124 proximate the internal central bore 135 with a second radius R2. The second radius R2 also reduces losses in the pressurized fluid as it turns into the respective outlet conduit 134. In one example, the second radius R2 is about 0.05 millimeters (mm) to about 0.25 millimeters (mm). Thus, generally, the radii R1, R2 remove obstacles that may otherwise impede the ability of the pressurized fluid to flow into the outlet conduits 134, and also inhibit the formation of dead zones or area with little to no airflow. It should be noted that the additive manufacturing of the weld nut feeder pin 100 enables the formation of the radius R2, which improves the flow of the pressurized fluid onto the weld nut 102.

With reference to FIG. 5, an end view of the weld nut feeder pin 100 is shown. The outlet conduits 134 are spaced substantially evenly apart about the perimeter or circumference of the pin body 124, and in this example, are spaced an angle β apart from each other about the perimeter. In one example, the angle β is about 120 degrees. By substantially evenly spacing the outlet conduits 134 about the perimeter of the pin body 124, the pressurized fluid is directed onto the weld flange 110 about a perimeter or circumference of the weld flange 110, which ensures that the weld nut 102 is retained on and delivered to the lower electrode 14 in the proper orientation.

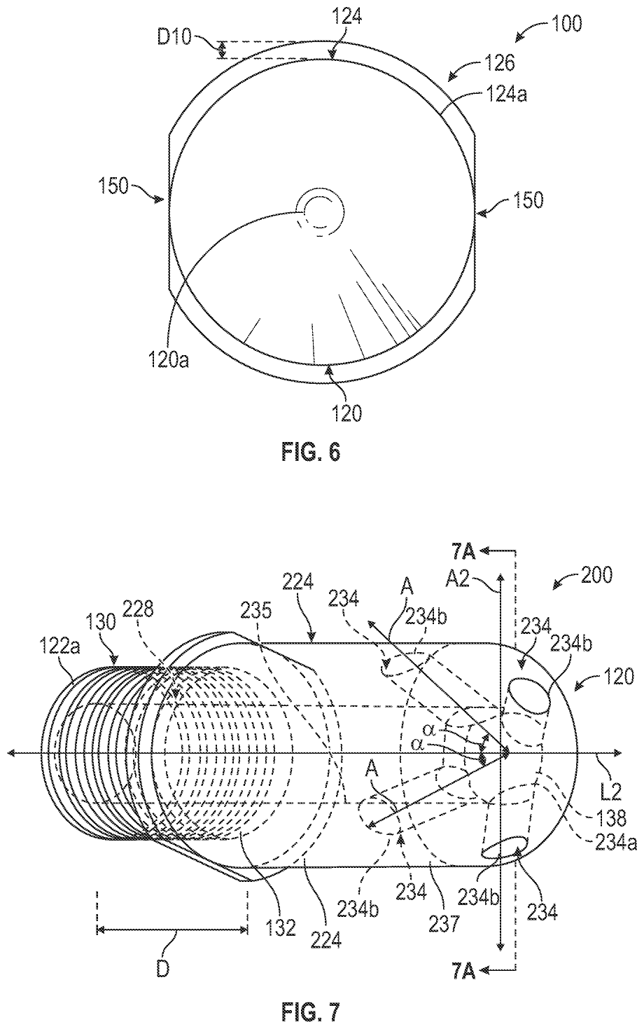

With reference back to FIG. 2, the pin flange 126 is defined at an end of the pin body 124 so as to be spaced apart from the first pin end 120 and the second pin end 122. The pin flange 126 provides a seat for the weld nut 102 when the weld nut 102 is coupled to the weld nut feeder pin 100. In one example, with reference to FIG. 6, the pin flange 126 generally extends for a distance D10 radially beyond and substantially perpendicular to the exterior surface 124a of the pin body 124 to define the seat. In one example, the pin flange 126 extends for the distance D10, which is about 0.25 millimeters (mm) to about 1.0 millimeters (mm). Generally, the diameter D10 is based on a diameter of the cylinder 40. In this example, the pin flange 126 also includes a pair of tool flats 150. The tool flats 150 are defined so as to be opposite each other on the pin flange 126. The tool flats 150 are planar surfaces, which enable a tool, such as a wrench, to grip the weld nut feeder pin 100. It should be noted that in other examples, the pin flange 126 may include a plurality of planar surfaces to define a surface for mating with a predetermined tool about the perimeter of the pin flange 126 or may be annular and devoid of the tool flats 150.

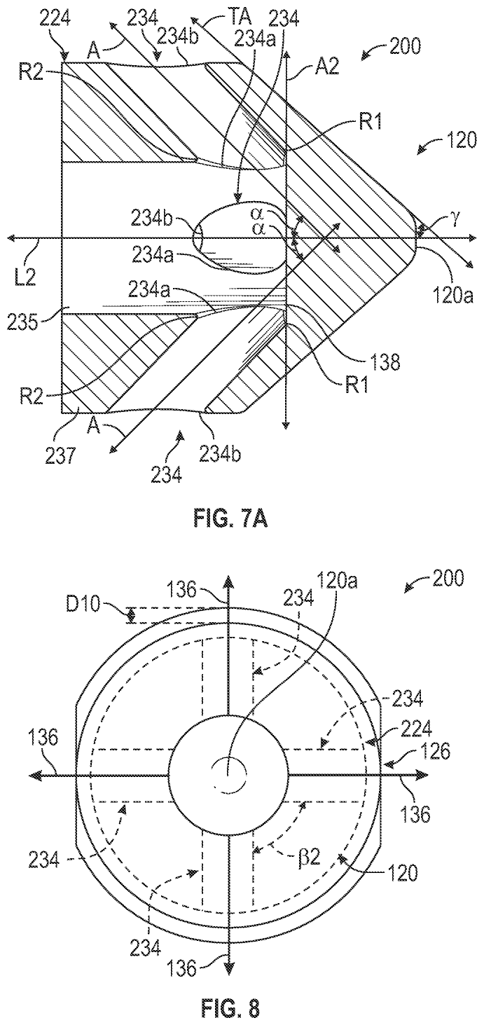

In addition, it should be noted that while the weld nut feeder pin 100 is shown and described in FIGS. 1-6 as including the pin body 124 that defines three outlet conduits 134 fluidly coupled to the pin fluid conduit 128, in other embodiments, the weld nut feeder pin 100 may include a different number of outlet conduits to retain the weld nut 102 on the weld nut feeder pin 100. For example, with reference to FIG. 7, a weld nut feeder pin 200 is shown for use with the nut feeder system 10 (FIG. 1). As the weld nut feeder pin 200 includes components that are the same or similar to components of the weld nut feeder pin 200 discussed with regard to FIGS. 1-6, the same reference numerals will be used to denote the same or similar components. The weld nut feeder pin 200 is composed of a polymer based material, including, but not limited to glass fiber-filled nylon 12. The use of glass fibers for reinforcement of the nylon improves an abrasion resistance of the weld nut feeder pin 200. It should be noted, however, that different polymer based materials and/or different reinforcement materials may be employed to manufacture the weld nut feeder pin 200 based on the particular nut feed system or manufacturing system. The weld nut feeder pin 200 is additively manufactured, via selective laser sintering (SLS), for example. By additively manufacturing the weld nut feeder pin 200, the weld nut feeder pin 200 may be easily replaced and easily manufactured to account for various sizes of weld nuts 102. The weld nut feeder pin 200 includes the first pin end 120 (FIG. 8), the second pin end 122, a pin body 224, the pin flange 126 and a pin fluid conduit 228. As will be discussed, the pin fluid conduit 228 extends from the second pin end 122 through the pin body 224 and terminates within the first pin end 120.

The first pin end 120 is opposite the second pin end 122. The first pin end 120 generally extends from the first terminal end 120a along the taper axis TA, which is oblique to a longitudinal axis L2 of the weld nut feeder pin 200 (FIG. 7A). A chamfer is defined between the first pin end 120 and the pin body 224 to further assist in seating the weld nut 102 on the weld nut feeder pin 200. The second pin end 122 includes the plurality of pin threads 130 over the threaded distance D. The unthreaded region 132 is defined between the pin threads 130 and the pin flange 126.

The pin body 224 is cylindrical, and interconnects the first pin end 120 and the pin flange 126. In this example, the pin body 224 defines the plurality of outlet conduits 234, and an internal central bore 235 that defines a portion of the pin fluid conduit 228. The outlet conduits 234 are in fluid communication with the pin fluid conduit 228 via the internal central bore 235, and distribute the pressurized fluid outward from the pin body 224 to retain the weld nut 102 on the pin body 224 during transportation of the weld nut 102 to the lower electrode 14 (FIG. 1). In this example, the pin body 124 has four outlet conduits 234 (FIG. 8). The outlet conduits 234 are each in communication with the pin fluid conduit 228 via the internal central bore 235, which is defined through a center of the weld nut feeder pin 200. Generally, the pin fluid conduit 228 extends along the longitudinal axis L2 of the weld nut feeder pin 200, which also comprises a centerline for internal central bore 235 and the pin fluid conduit 228. In this example, with additional reference to FIG. 7A, each of the outlet conduits 234 extends along the axis A, which is substantially oblique to the longitudinal axis L2. The axis A is substantially a centerline of each of the outlet conduits 234. Stated another way, each of the outlet conduits 234 is defined along the axis A so as to be at the angle a relative to the longitudinal axis L2. By defining the outlet conduits 234 along the axis A, at the angle a, each of the outlet conduits 234 directs the pressurized airflow substantially along the direction of the arrows 136 (FIG. 8) onto the weld flange 110. This retains the weld nut 102 on the weld nut feeder pin 200 as the rod 42 moves to position the weld nut 102 on the lower electrode 14 (FIG. 1).

Each of the outlet conduits 234 is cylindrical and has an inlet or first outlet end 234a opposite an outlet or second outlet end 234b. As each of the outlet conduits 234 is cylindrical, the first outlet end 234a and the second outlet end 234b are each circular. The outlet conduits 234 are defined through a sidewall 237 of the pin body 224. The sidewall 237 surrounds the internal central bore 235, and the sidewall 237 has a reduced thickness to enable the internal central bore 235 to supply a larger volume of the pressurized fluid to the outlet conduits 234. The first outlet end 234a is defined at least partially within the first pin end 120, and the second outlet end 234b is defined at an exterior surface 224a of the pin body 224. In one example, each of the outlet conduits 234 is defined uniformly, with a constant diameter along a length of each of the outlet conduits 234 from the first outlet end 234a to the second outlet end 234b. In one example, each of the outlet conduits 234 has a diameter of about 2.0 millimeters (mm) to about 2.5 millimeters (mm). It should be noted that in other examples, the first outlet end 234a may have a diameter that is different that a diameter of the second outlet end 234b. Each of the outlet conduits 234 connects to the internal central bore 235 that defines the pin fluid conduit 228 to direct the pressurized fluid through the sidewall 237 of the pin body 224 to the exterior surface 224a to contact the weld nut 102. Generally, the pin fluid conduit 228 is defined through the weld nut feeder pin 200 so as to be substantially cylindrical. In one example, the pin fluid conduit 228 is defined as a cylindrical counterbore, which extends from the second terminal end 122a to proximate the first terminal end 120a. In this example, the pin fluid conduit 228 terminates or ends within the first pin end 120 along the planar endwall 138. The endwall 138 extends along the axis A2, which is substantially perpendicular to the longitudinal axis L2, and substantially oblique to the axis A of each of the outlet conduits 234. By terminating at the endwall 138, the pressurized fluid is directed into each of the outlet conduits 234. In one example, the pin fluid conduit 228 has a diameter of about 4.0 millimeters (mm) to about 5.0 millimeters (mm).

It should be noted that the first outlet end 234a of each of the outlet conduits 234 is integrally formed with the endwall 138 along the radius R1, which assists in directing the pressurized fluid into the respective outlet conduit 234. In addition, the first outlet end 234a of each of the outlet conduits 234 is integrally formed with the sidewall 237 of the pin body 224 with the radius R2. The radius R2 reduces losses in the pressurized fluid as it turns into the respective outlet conduit 234. By providing the weld nut feeder pin 200 with the four outlet conduits 234, the weld nut feeder pin 200 may be used to secure larger size weld nuts 102 to the weld nut feeder pin 200. For example, the weld nut feeder pin 200 may be used to secure metric 12 millimeter (mm) weld nuts 102 (M12) or metric 16 millimeter (mm) weld nuts 102 (M16), while the weld nut feeder pin 100 may be used to secure metric 6 millimeter (mm) weld nuts 102 (M6) or metric 8 millimeter (mm) weld nuts 102 (M8). The pin fluid conduit 228 is in fluid communication with the rod fluid passage 54 to receive the pressurized fluid from the pressurized fluid source 44. Stated another way, the pin fluid conduit 228 is fluidly coupled to the pressurized fluid source 44.

With reference to FIG. 8, an end view of the weld nut feeder pin 200 is shown. The outlet conduits 234 are spaced substantially evenly apart about the perimeter or circumference of the pin body 224, and in this example, are spaced an angle β2 apart from each other about the perimeter. In one example, the angle β2 is about 90 degrees. By substantially evenly spacing the outlet conduits 234 about the perimeter of the pin body 224, the pressurized fluid is directed onto the weld flange 110 about a perimeter or circumference of the weld flange 110, which ensures that the weld nut 102 is retained on and delivered to the lower electrode 14 in the proper orientation.

The pin flange 126 provides a seat for the weld nut 102 when the weld nut 102 is coupled to the weld nut feeder pin 200 (like shown in FIG. 2). In one example, the pin flange 126 generally extends for the distance D10 radially beyond and substantially perpendicular the exterior surface 224a of the pin body 224 to define the seat, and in this example, includes the pair of tool flats 150.

As discussed, with reference to FIGS. 1-3 and 7, the weld nut feeder pin 100, 200 is additively manufactured, via SLS. Generally, the weld nut feeder pin 100, 200 is formed or built along a build direction that is substantially parallel with the longitudinal axis L, L2. This enables the weld nut feeder pin 100, 200 to be self-supporting during additive manufacture, which eliminates the need for supports and support removal upon completion of the additive manufacturing. In addition, by forming the first outlet end 134a, 234a, with the radii R1, R2, build powder remaining within the weld nut feeder pin 100, 200 after additive manufacturing may be easily removed. Due to the use of SLS, the weld nut feeder pin 100, 200 does not require additional processing, such as surface finish treatments. With the weld nut feeder pin 100, 200 formed, the weld nut feeder pin 100, 200 is coupled to the second rod end 48 via engagement of the pin threads 130 with the rod threads 52. The tool flats 150 may be used with a suitable tool, such as a wrench, to assist in coupling the weld nut feeder pin 100, 200 to the rod 42. With the weld nut feeder pin 100, 200 coupled to the rod 42, the nut feeder system 10 is ready for use within the manufacturing system 8.

For example, the nut feeder system 10 may be activated to supply the weld nut 102 to the component 16 for welding by the weld system 12. In this example, the nut supply source 32 is activated to supply the weld nut 102 to the rod 42 in the retracted position. The pressurized fluid source 44 is activated to supply the pressurized fluid to the cylinder 40 and the pressurized fluid causes the rod 42 to move from the retraced position toward the extended position such that the weld nut feeder pin 100, 200 is received through the weld nut 102 and the weld nut 102 is seated on the pin flange 126. Substantially simultaneously, the pressurized fluid from the pressurized fluid source 44 flows through the rod fluid passage 54 and the pin fluid conduit 128, 228, and exits through the outlet conduits 134, 234 onto the weld flange 110. The pressurized fluid acting on the weld flange 110 retains the weld nut 102 on the weld nut feeder pin 100, 200 as the rod 42 moves from the retracted position to the extended position to position the weld nut 102 on the lower electrode 14.

Thus, the weld nut feeder pin 100, 200 retains the weld nut 102 securely on the weld nut feeder pin 200 as the rod 42 transports or moves the weld nut 102 to the lower electrode 14. The use of the plurality of outlet conduits 134, 234 spaced apart about the perimeter of the respective weld nut feeder pin 100, 200 ensures that the pressurized fluid is directed onto the weld flange 110 about the perimeter of the weld nut 102, which assists in retaining the weld nut 102 while also ensuring an orientation of the weld nut 102. The pin flange 126 also acts as a seat, which further secures the weld nut 102 onto the weld nut feeder pin 100, 200 as the rod 42 moves toward the lower electrode 14. Further, by forming the first pin end 120 to extend along the taper axis TA, at the angle γ, the first pin end 120 guides the weld nut 102 onto the weld nut feeder pin 100, 200, which ensures that the weld nut 102 is seated on the weld nut feeder pin 100 as the rod 42 moves to the extended position.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A weld nut feeder pin, comprising:
a first pin end opposite a second pin end;
a pin body that extends from the first pin end toward the second pin end;
a pin fluid conduit defined by a cylindrical sidewall through the second pin end to extend to the first pin end and through the pin body, the pin fluid conduit configured to receive a pressurized fluid, wherein the pin fluid conduit terminates within the first pin end at a planar endwall; and
a plurality of outlet conduits defined through the pin body and in communication with the pin fluid conduit, with each of the plurality of outlet conduits spaced apart about a perimeter of the pin body and extending along an axis oblique to a longitudinal axis of the weld nut feeder pin, wherein
a first outlet end of each outlet conduit is integrally formed with the endwall at a radius R1 from the longitudinal axis;
a second outlet end of each outlet conduit is integrally formed with the cylindrical sidewall at a radius R2 from the longitudinal axis;
radius R1>radius R2; and
the weld nut feeder pin is additively manufactured from a polymer-based material.

2. The weld nut feeder pin of claim 1, wherein the each outlet conduit has an inner opening formed in the cylindrical sidewall and in the end wall, wherein each inner opening lies in a respective opening plane that is oblique to the longitudinal axis.

3. The weld nut feeder pin of claim 1, wherein the planar endwall extends along a second axis, and the second axis is substantially perpendicular to the longitudinal axis.

4. The weld nut feeder pin of claim 1, wherein each of the plurality of outlet conduits extend along the axis to be defined at an angle relative to the longitudinal axis, and the angle is an acute angle.

5. The weld nut feeder pin of claim 4, wherein the angle is less than fifty degrees.

6. The weld nut feeder pin of claim 1, wherein the plurality of outlet conduits are substantially evenly spaced apart about the perimeter of the pin body and have a uniform diameter along the axis.

7. The weld nut feeder pin of claim 1, wherein the first pin end tapers to a first terminal end, and the second pin end includes a second terminal end, with a plurality of threads defined on the weld nut feeder pin from the second terminal end toward the pin body.

8. The weld nut feeder pin of claim 7, wherein the plurality of threads are spaced apart from the pin body by an unthreaded region.

9. The weld nut feeder pin of claim 1, further comprising a pin flange located between the first pin end and the second pin end, and the pin flange is configured to be a seat for a weld nut associated with a nut feeder system.

10. The weld nut feeder pin of claim 9, wherein the pin flange includes a pair of opposed tool flats that are configured to receive a tool.

11. The weld nut feeder pin of claim 1, wherein radius R1 is about 0.05 millimeters (mm) to about 0.25 millimeters (mm) and radius R2 is about 0.05 millimeters (mm) to about 0.25 millimeters (mm).

12. The weld nut feeder pin of claim 1, wherein the pin fluid conduit is defined as a counterbore.

13. The weld nut feeder pin of claim 1, wherein each outlet conduit has a distal edge formed by the endwall, each outlet conduit has a proximal edge defined by the cylindrical sidewall, and for each outlet conduit a line defined by the distal edge and the proximal edge is oblique to the longitudinal axis.

14. A weld nut feeder pin, comprising:
a first pin end opposite a second pin end;
a pin body that extends from the first pin end toward the second pin end, the pin body defining a sidewall and a central bore;
a pin fluid conduit defined to extend through the second pin end and through the central bore of the pin body to terminate at an endwall defined within the first pin end, the pin fluid conduit configured to receive a pressurized fluid; and
a plurality of outlet conduits defined through the pin body and in communication with the pin fluid conduit, each of the plurality of outlet conduits spaced apart substantially evenly about a perimeter of the pin body, each of the plurality of outlet conduits extending at an angle relative to a longitudinal axis of the weld nut feeder pin, wherein the angle is an acute angle, and wherein
a first outlet end of each outlet conduit is integrally formed with the endwall at a radius R1 from the longitudinal axis;
a second outlet end of each outlet conduit is integrally formed with the cylindrical sidewall at a radius R2 from the longitudinal axis;
radius R1>radius R2; and
the weld nut feeder pin is additively manufactured from a polymer-based material.

15. The weld nut feeder pin of claim 14, wherein each of the plurality of outlet conduits extend along a first axis that is oblique to the longitudinal axis, each of the plurality of outlet conduits has a uniform diameter along the first axis, the endwall extends along a second axis, and the second axis is substantially perpendicular to the longitudinal axis.

16. The weld nut feeder pin of claim 14, further comprising a pin flange located between the first pin end and the second pin end, and the pin flange is configured to be a seat for a weld nut associated with a nut feeder system.

17. The weld nut feeder pin of claim 16, wherein the pin flange includes a pair of opposed tool flats that are configured to receive a tool.

18. The weld nut feeder pin of claim 14, wherein the first pin end tapers to a first terminal end, and the second pin end includes a second terminal end, with a plurality of threads defined on the weld nut feeder pin from the second terminal end toward the pin body.

19. The weld nut feeder pin of claim 18, wherein the plurality of threads are spaced apart from the pin body by an unthreaded region.

20. The weld nut feeder pin of claim 14, wherein each outlet conduit has an inner opening formed in the cylindrical sidewall and in the end wall, wherein each inner opening lies in a respective opening plane that is oblique to the longitudinal axis.
